(19) United States
(12) Patent Application Publication
(10) Pub. No.: US 2024/0095779 A1
(43) Pub. Date: Mar. 21, 2024

(54) DEMAND SIDE PLATFORM IDENTITY GRAPH ENHANCEMENT THROUGH MACHINE LEARNING (ML) INFERENCING

(71) Applicant: ROKU, INC., San Jose, CA (US)

(72) Inventors: Sayan MAITY, San Jose, CA (US); Maurice KLAUS, San Jose, CA (US); Beth LOGAN, San Jose, CA (US); Dhruv SHAH, San Jose, CA (US)

(73) Assignee: ROKU, INC., San Jose, CA (US)

(21) Appl. No.: 17/932,985

(22) Filed: Sep. 16, 2022

(51) Int. Cl. G06Q 30/02; G06N 5/02; G06N 5/04

(52) U.S. Cl. CPC G06Q 30/0275; G06N 5/022; G06N 5/04

(57) ABSTRACT

Disclosed herein are system, apparatus, article of manufacture, method and/or computer program product embodiments, and/or combinations and sub-combinations thereof, for enhancing a deterministic identity graph with probabilistic data. An example embodiment operates by identifying a node for a location indicated by an identity graph. Receiving user device information based on an indication that a user device is within proximity to the location. Generating a node for the user device on the identity graph based on the indication of the user device satisfying an association threshold. Generating an edge between the node for the location and the node for the user device based on a weighted value for an attribute of the user information. Mapping an identifier for the user device to an identifier of the location based on a distance of the edge and causing a content item to be sent to the user device based on the identifier mapping.

### BACKGROUND

### Field

This disclosure is generally directed to enhancing a deterministic identity graph with probabilistic data, and more particularly to associating probabilistic graph-related data with deterministic graph-related data to facilitate content delivery.

### Background

A “bid stream” represents the multi-hop information flow in a real-time-bidding (RTB) framework to match advertising creatives with the available ad inventories. Real-time bidding (RTB) is a programmatic advertising technology designed for the automatic buying and selling of advertisement impressions in real-time. All the device information, user information, advertisement content information, and/or the like collected in this programmatic advertisement serving lifecycle is referred to as bid stream data. Content providers (e.g., content publishing entities, advertising entities, content marketing entities, content creators, content service providers, etc.) use identity graphs (e.g., look-up tables, data onboarding, etc.) to identify user devices and/or identify user locations. Identified user devices and/or user locations may be used for advertisement targeting and/or any other bid stream-related activities. However, advertisers are unable to reach out to broader sets of user/devices using identity graphs solely built on deterministic information to target such user/devices for content-related communications (e.g., bid stream data, etc.) and/or evaluate (e.g., quantify, qualify, etc.) content-related communications associated with such user devices.

### SUMMARY

Provided herein are system, apparatus, article of manufacture, method and/or computer program product embodiments, and/or combinations and sub-combinations thereof, for enhancing a deterministic identity graph with probabilistic data. According to some aspects of this disclosure, a computing system may use communication-related information including, but not limited to, content request/acquisition information, identifier information (e.g., an Internet Protocol (IP) address, a service provider and/or business entity identifier, first-part cookies, third-party cookies, identifier for advertisers (IDFA), a generic identifier for advertising (IFA), device-specific identifiers, a media access control (MAC) address, a service identifier, an international mobile equipment identity (IMEI), a session identifier, etc.), location information, and/or the like, to identify a probable (e.g., the most probable, least probable, etc.) deterministic location (e.g., a household, an geographic address, a premise, etc.) association for a user device. The location association for the user device may be used to facilitate content and/or content items being sent to the user device.

According to some aspects of this disclosure, an example embodiment operates by identifying a node for a location indicated by an identity graph that identifies user devices associated with locations based on location information. Receiving user device information based on an indication that a user device is within proximity to the location. Generating a node for the user device indicated by the identity graph based on the indication of the user device satisfying an association threshold that indicates whether unidentified user devices are associated with locations. Generating an edge between the node for the location and the node for the user device based on a weighted value for an attribute of the user information. Mapping an identifier for the user device to an identifier of the location based on a distance of the edge being less than a distance threshold that indicates degrees of association between nodes of the identity graph. Moreover, causing a content item to be sent to the user device based on the identifier for the user device being mapped to the identifier of the location.

According to aspects of this disclosure, all device information, user information, advertisement content information, and/or the like collected, managed, and/or described herein is utilized in accordance with and as permitted by any internet/data privacy laws, user privacy/consent laws, and/or the like.

### BRIEF DESCRIPTION OF THE FIGURES

The accompanying drawings are incorporated herein and form a part of the specification.

FIG. 1 illustrates a block diagram of a multimedia environment, according to some embodiments.

FIG. 2 illustrates a block diagram of a streaming media device, according to some embodiments.

FIG. 3 illustrates an example system for training an identity management module that may be used for enhancing a deterministic identity graph with probabilistic data, according to some embodiments.

FIG. 4 illustrates a flowchart of an example training method for generating a machine learning classifier to classify data used for enhancing a deterministic identity graph with probabilistic data, according to some embodiments.

FIG. 5 illustrates a flowchart of an example method for enhancing a deterministic identity graph with probabilistic data, according to some embodiments.

FIG. 6 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for enhancing a deterministic identity graph with probabilistic data.

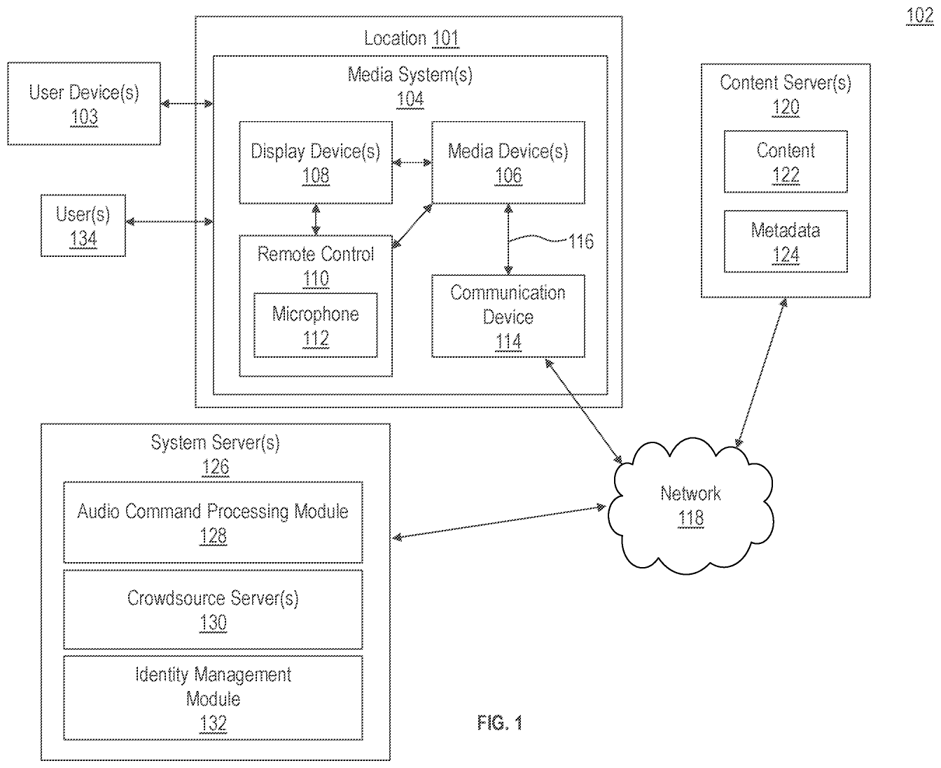

Various embodiments of this disclosure may be implemented using and/or may be part of a multimedia environment 102 shown in FIG. 1. It is noted, however, that multimedia environment 102 is provided solely for illustrative purposes, and is not limiting. Embodiments of this disclosure may be implemented using and/or may be part of environments different from and/or in addition to the multimedia environment 102, as will be appreciated by persons skilled in the relevant art(s) based on the teachings contained herein. An example of the multimedia environment 102 shall now be described.

Multimedia Environment FIG. 1 illustrates a block diagram of a multimedia environment 102, according to some embodiments. In a non-limiting example, multimedia environment 102 may be directed to streaming media. However, this disclosure is applicable to any type of media (instead of or in addition to streaming media), as well as any mechanism, means, protocol, method and/or process for distributing media.

According to some aspects of this disclosure, the multimedia environment 102 may include one or more location(s) 101. According to some aspects of this disclosure, a location(s) 101 may represent a single-family house, a condo, an apartment, and/or the like where devices will be used to consume content, media (e.g., streaming content, linear television, web browsing, etc.), and/or the like on a permanent basis (e.g., a deterministic location, etc.). User(s) 134 may operate with the media system 104 to select and consume content. A location 101 may include one or more media system(s) 104 (e.g., a group/collection of media-related devices, components, elements, etc.).

According to some aspects of this disclosure, the each media system 104 may include one or more media devices 106 each coupled to one or more display devices 108. It is noted that terms such as “coupled,” “connected to,” “attached,” “linked,” “combined” and similar terms may refer to physical, electrical, magnetic, logical, etc., connections, unless otherwise specified herein.

According to some aspects of this disclosure, the media device 106 may be a streaming media device, DVD or BLU-RAY device, audio/video playback device, cable box, and/or digital video recording device, to name just a few examples. Display device 108 may be a monitor, television (TV), computer, mobile device, smart device, tablet, wearable (such as a watch or glasses), appliance, internet of things (IoT) device, and/or projector, to name just a few examples. In some embodiments, media device 106 can be a part of, integrated with, operatively coupled to, and/or connected to its respective display device 108.

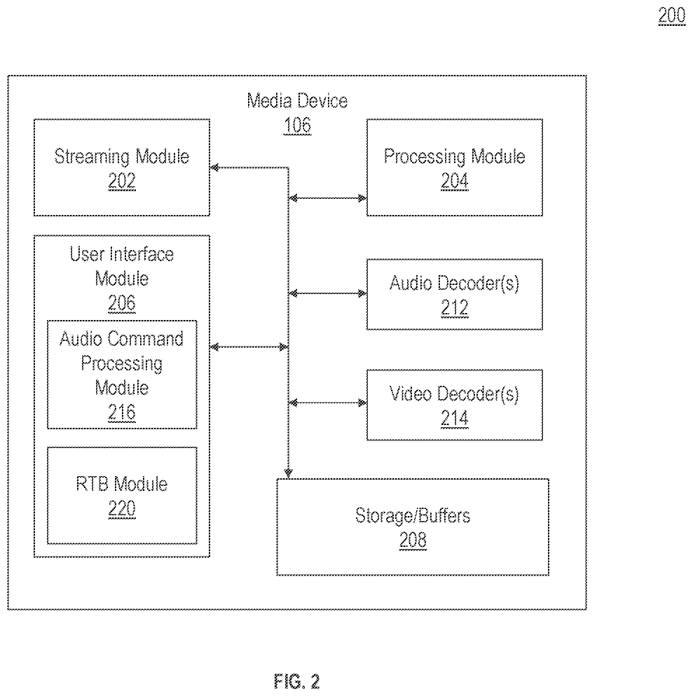

FIG. 2 illustrates a block diagram 200 of an example media device 106, according to some embodiments. Media device 106 may include a streaming module 202, processing module 204, storage/buffers 208, and user interface module 206. The user interface module 206 may include an audio command processing module 216.

According to some aspects of this disclosure, the media device 106 may include one or more audio decoders 212 and one or more video decoders 214. Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples. Similarly, each video decoder 214 may be configured to decode video of one or more video formats, such as but not limited to MP4 (mp4, m4a, m4v, f4v, f4a, m4b, m4r, f4b, mov, etc.), 3GP (3gp, 3gp2, 3g2, 3gpp, 3gpp2, etc.), OGG (ogg, oga, ogv, ogx, etc.), WMV (wmv, wma, asf, etc.), WEBM, FLV, AVI, QuickTime, HDV, MXF (OP1a, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to H.263, H.264, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

According to some aspects of this disclosure, the media device 106 may include a real-time bidding (RTB) module 220. According to some aspects of this disclosure, the RTB module 220 may facilitate buying of advertising inventory. According to some aspects of this disclosure, the RTB module may manage processes for building and managing a bid stream (e.g., accepting Reservation Right requests, calculating bid stream status and statistics, calculating allotments and pricing, etc.). According to some aspects of this disclosure, the RTB module 220 may utilize database technology (e.g., Oracle, DB2, etc.) with custom programming, and include support other services (e.g., caching, persistence technology, object services, replication, versioning, etc.).

Returning to FIG. 1, each media device 106 may be configured to communicate with network 118 via a communication device 114. The communication device 114 may include, for example, a cable modem or satellite TV transceiver. The media device 106 may communicate with the communication device 114 over a link 116, wherein the link 116 may include wireless (such as Wi-Fi) and/or wired connections.

According to some aspects of this disclosure, the network 118 can include, without limitation, wired and/or wireless intranet, extranet, Internet, cellular, Bluetooth, infrared, and/or any other short-range, long-range, local, regional, global communications mechanism, means, approach, protocol and/or network, as well as any combination(s) thereof

According to some aspects of this disclosure, media system 104 may include a remote control 110. The remote control 110 can be any component, part, apparatus, and/or method for controlling the media device 106 and/or display device 108, such as a remote control, a tablet, laptop computer, smartphone, wearable, on-screen controls, integrated control buttons, audio controls, or any combination thereof, to name just a few examples. In an embodiment, the remote control 110 wirelessly communicates with the media device 106 and/or display device 108 using cellular, Bluetooth, infrared, etc., or any combination thereof. The remote control 110 may include a microphone 112, which is further described below.

According to some aspects of this disclosure, the multimedia environment 102 may include a plurality of content servers 120 (also called content providers, channels, or sources 120). Although only one content server 120 is shown in FIG. 1, in practice the multimedia environment 102 may include any number of content servers 120. Each content server 120 may be configured to communicate with network 118.

According to some aspects of this disclosure, each content server 120 may store content 122 and metadata 124. According to some aspects of this disclosure, content 122 may include advertisements, promotional content, commercials, and/or any advertisement-related content. According to some aspects of this disclosure, content 122 may include any combination of advertising supporting content including, but not limited to, content items (e.g. movies, episodic serials, documentaries, etc.), music, videos, movies, TV programs, multimedia, images, still pictures, text, graphics, gaming applications, ad campaigns, programming content, public service content, government content, local community content, software, and/or any other content and/or data objects in electronic form.

According to some aspects of this disclosure, metadata 124 comprises data about content 122. For example, metadata 124 may include associated or ancillary information indicating or related to writer, director, producer, composer, artist, actor, summary, chapters, production, history, year, trailers, alternate versions, related content, applications, objects depicted in content and/or content items, object types, closed captioning data/information, audio description data/information, and/or any other information pertaining or relating to the content 122. Metadata 124 may also or alternatively include links to any such information pertaining or relating to the content 122. Metadata 124 may also or alternatively include one or more indexes of content 122, such as but not limited to a trick mode index.

According to some aspects of this disclosure, the multimedia environment 102 may include one or more system server(s) 126. The system server(s) 126 may operate to support the media devices 106 from the cloud. It is noted that the structural and functional aspects of the system server(s) 126 may wholly or partially exist in the same or different ones of the system server(s) 126.

According to some aspects of this disclosure, the system server(s) 126 may include an audio command processing module 128. As noted above, the remote control 110 may include a microphone 112. The microphone 112 may receive audio data from users 134 (as well as other sources, such as the display device 108). In some embodiments, the media device 106 may be audio responsive, and the audio data may represent verbal commands from the user 134 to control the media device 106 as well as other components in the media system 104, such as the display device 108.

According to some aspects of this disclosure, the audio data received by the microphone 112 in the remote control 110 is transferred to the media device 106, which is then forwarded to the audio command processing module 128 in the system server(s) 126. The audio command processing module 128 may operate to process and analyze the received audio data to recognize the user 134's verbal command. The audio command processing module 128 may then forward the verbal command back to the media device 106 for processing.

According to some aspects of this disclosure, the audio data may be alternatively or additionally processed and analyzed by an audio command processing module 216 in the media device 106 (see FIG. 2). The media device 106 and the system server(s) 126 may then cooperate to pick one of the verbal commands to process (either the verbal command recognized by the audio command processing module 128 in the system server(s) 126, or the verbal command recognized by the audio command processing module 216 in the media device 106).

Now referring to both FIGS. 1 and 2, in some embodiments, the user 134 may interact with the media device 106 via, for example, the remote control 110. For example, the user 134 may use the remote control 110 to interact with the user interface module 206 of the media device 106 to select content, such as a movie, TV show, music, book, application, game, etc. The streaming module 202 of the media device 106 may request the selected content from the content server(s) 120 over the network 118. The content server(s) 120 may transmit the requested content to the streaming module 202. The media device 106 may transmit the received content to the display device 108 for playback to the user 134.

According to some aspects of this disclosure, the media system 104 may include devices and/or components supporting and/or facilitating linear television, inter-device/component communications (e.g., HDMI inputs connected to gaming devices, etc.), on-line communications (e.g., Internet browsing, etc.) and/or the like.

According to some aspects of this disclosure, for example, in streaming embodiments, the streaming module 202 may transmit the content to the display device 108 in real-time or near real-time as it receives such content from the content server(s) 120. In non-streaming embodiments, the media device 106 may store the content received from content server(s) 120 in storage/buffers 208 for later playback on display device 108.

According to some aspects of this disclosure, the media devices 106 may exist in thousands or millions of media systems 104. Accordingly, the media devices 106 may lend themselves to crowdsourcing embodiments and, thus, the system server(s) 126 may include one or more crowdsource server(s) 130.

According to some aspects of this disclosure, using information received from the media devices 106 in the thousands and millions of media systems 104, the crowdsource server(s) 130 may identify similarities and overlaps between closed captioning requests issued by different users 134 watching a content item, advertisement, and/or the like. Based on such information, the crowdsource server(s) 130 may determine that turning closed captioning on may enhance users' viewing experience at particular portions of the content item, advertisement, and/or the like (for example, when the soundtrack of the content item, advertisement, and/or the like is difficult to hear), and turning closed captioning off may enhance users' viewing experience at other portions of the content item, advertisement, and/or the like (for example, when displaying closed captioning obstructs critical visual aspects of the content item, advertisement, and/or the like). Accordingly, the crowdsource server(s) 130 may operate to cause closed captioning to be automatically turned on and/or off during future streamings of the content item, advertisement, and/or the like.

According to some aspects of this disclosure, using information received from the media devices 106 (and/or user device(s) 103) in the thousands and millions of media systems 104, the crowdsource server(s) 130 may identify media devices (and/or user devices) to target with and/or acquire from bid stream data, communications, information, and/or the like. For example, the most popular content and/or content items may be determined based on the amount of content and/or content items are requested (e.g., viewed, accessed, etc.) by media devices 106. The crowdsource server(s) 130 may identify similarities, such as common attributes, features, elements, and or the like, between content and/or content items. For example, the crowdsource server(s) 130 may detect and classify similar cartoon objects across all animated content and/or content items. The crowdsource server(s) 130 may detect and classify any attribute, feature, element, object, and/or the like associated with or depicted by any type of content and/or content items.

The multimedia environment 102 may include one or more user device(s) 103 (e.g., mobile devices, smart devices, computing devices, bid stream-related devices, etc.). According to some aspects of this disclosure, a user device 103 may be an unidentified user device. An unidentified user device may be any user device that is not associated with and/or mapped to deterministic data (e.g., an identity graph, a look-up table, etc.) and/or a deterministic location (e.g., location 101, etc.), but still detected and/or identified to be in proximity to location 101 and/or have an association (e.g., an indication of frequent proximity, historical/real-time communication, etc.) with one or more of the media device(s) 106, the communication device 114, and/or the like.

According to some aspects of this disclosure, the system server(s) 126 may include an identity management module 132. The identity management module 132 may use processing techniques, such as artificial intelligence, statistical models, logical processing algorithms, and/or the like to facilitate bid stream activity and/or device identification. The identity management module 132 may use processing techniques, such as artificial intelligence, statistical models, logical processing algorithms, and/or the like to facilitate enhancing, modifying, updating, and/or the like a deterministic identity graph with probabilistic data. For example, the identity management module 132 uses processing techniques, such as artificial intelligence, statistical models, logical processing algorithms, and/or the like to facilitate graph inferencing, for example, to modify and/or enhance a deterministic identity graph with probabilistic data/information.

The identity module 132 may use various processing techniques to identify, classify, and/or associate unidentified user devices with deterministic data (e.g., identity graphs, look-up tables, data onboarding information, etc.). According to some aspects of this disclosure, the identity management module 132 may use classifiers that map an attribute vector to a confidence that the attribute belongs to a class. For example, the identity management module 132 may use classifiers that map vectors that represent attributes including, but not limited to both qualitative attributes and quantitative attributes, of user device information received, determined, detected, and/or identified for a user device. For example, an attribute vector, x=(x1, x2, x3, x4, xn) may be mapped to f(x)=confidence(class).

According to some aspects of this disclosure, identity management and/or bid stream-related activities performed by the identity management module 132 may employ a probabilistic and/or statistical-based analysis. According to some aspects of this disclosure, identity management and/or bid stream-related activities performed by the identity management module 132 may use any type of directed and/or undirected model classification approaches include, e.g., naïve Bayes, Bayesian networks, decision trees, neural networks, fuzzy logic models, and probabilistic classification models providing different patterns of independence. Classification may also include statistical regression that is utilized to develop models of priority.

According to some aspects of this disclosure, classifiers, for example, device type classifiers, content type classifiers, content source classifiers, content consumption and/or historical data classifiers, and/or the like, used by the identity management module 132 may be explicitly trained based on labeled datasets relating to various locations, devices, device types, content providers, service providers, content items, and/or the like. According to some aspects of this disclosure, classifiers, for example, such as device type classifiers, content type classifiers, content source classifiers, content consumption and/or historical data classifiers, and/or the like, used by the identity management module 132 may be implicitly trained (e.g., via results from identity management and/or classification tasks, etc.). For example, the identity management module 132 may include support vector machines configured via a learning or training phase within a classifier constructor and feature selection module.

According to some aspects of this disclosure, classifier(s) may be used by the identity management module 132 to automatically learn and perform functions, including but not limited to identity and/or determining advertising-related traffic/communications being facilitated via the multimedia environment 102 (e.g., in terms of what advertisements are displayed in what applications, in what websites, on what types of user devices and/or media devices, etc.).

The identity management module 132 may receive data indicating what content and/or advertising traffic is being obtained, accessed, requested, and/or consumed, obtained through the multimedia environment 102 (e.g., in terms of what advertisements are displayed in what applications, in what websites, on what types of user devices and/or media devices, etc.) and use the data (along with third-party data) to optimize classifiers used for identity management and/or content-related traffic forecasting and analysis. For example, optimized classifiers may be used to modify and/or enhance a deterministic identity graph with probabilistic data/information. A modified and/or enhance identity graph may be used to manage bid streams by evaluating and aligning inventory from a content provider, service provider, and/or entity so that a demand side of the multimedia environment 102 receives bid requests for impression opportunities that match the requirements for advertisers.

Enhancing a Deterministic Identity Graph with Probabilistic Data

Referring to FIG. 1, the media devices 106 may exist in thousands or millions of media systems 104. Accordingly, the media devices 106 may lend themselves to deterministic bid stream activity. In some embodiments, one or more components and/or devices of the system server(s) 126 (e.g., identity management model 132, etc.) operate to facilitate enhancing a deterministic identity graph with probabilistic data. Enhancing a deterministic identity graph with probabilistic data, for example, associating probabilistic user devices and/or user device information with deterministic user devices, device information, and/or locations may be used to increase/improve the accuracy and/or effectiveness of an identity management system. According to some aspects of this disclosure, identity management model 132 may assign probabilistic user devices (e.g., devices with alias identifiers, unidentified user devices, user device(s) 103, etc.) to a determined data cluster and/or deterministic identity graph.

For example, According to some aspects of this disclosure, identity management model 132 may identify a node for a location indicated by an identity graph. The identity graph may identify user devices associated with locations based on location information. For example, an identity graph may indicate devices/components of media system 104 are associated with location 101. Identity management model 132 may receive user device information based on an indication that user device 103 is within proximity to location 101. Identity management model 132 may generate a node for the user device 103 that is indicated by the identity graph based on the indication of the user device 103 satisfying an association threshold that indicates whether unidentified user devices are associated with locations.

According to some aspects of this disclosure, identity management model 132 may generate an edge between the node for the location and the node for the user device 103 based on a weighted value for an attribute of the user information. Identity management model 132 may map an identifier (e.g., IP address, service provider and/or business entity identifier, first-part cookie, third-party cookie, IDFA, generic IFA, device-specific identifier, MAC address, a service identifier, IMEI, a session identifier, etc.) for the user device 103 to an identifier of the location 101 based on a distance of the edge being less than a distance threshold that indicates degrees of association between nodes of the identity graph. Identity management model 132 may manage bid stream activity for the user device 103 based on the identifier for the user device being mapped to the identifier of the location. For example, identity management model 132 may cause a content item to be sent to the user device 103 based on the identifier for the user device 103 being mapped to the identifier of the location 101.

According to some aspects of this disclosure, to facilitate enhancing a deterministic identity graph with probabilistic data, the identity management module 132 may be trained to determine correspondences between user devices and user locations, for example, based on an analysis of data/information communicated from/to the user devices. Training the identity management module 132 to determine correspondences between user devices and user locations may assist in facilitating bid stream activities. For example, an advertising entity, device, component, user, and/or the like with an intent to reach more user devices, deliver more advertisement impressions, and/or the like may use data/information output by the identity management module 132 (e.g., an indication that a probabilistic user device is associated with a deterministic location, etc.) to manage key performance indicators (KPIs) including, but not limited to KPI's identifying a maximize reach per bid stream, minimizing cost per actions, maximizing action through rates, and/or the like.

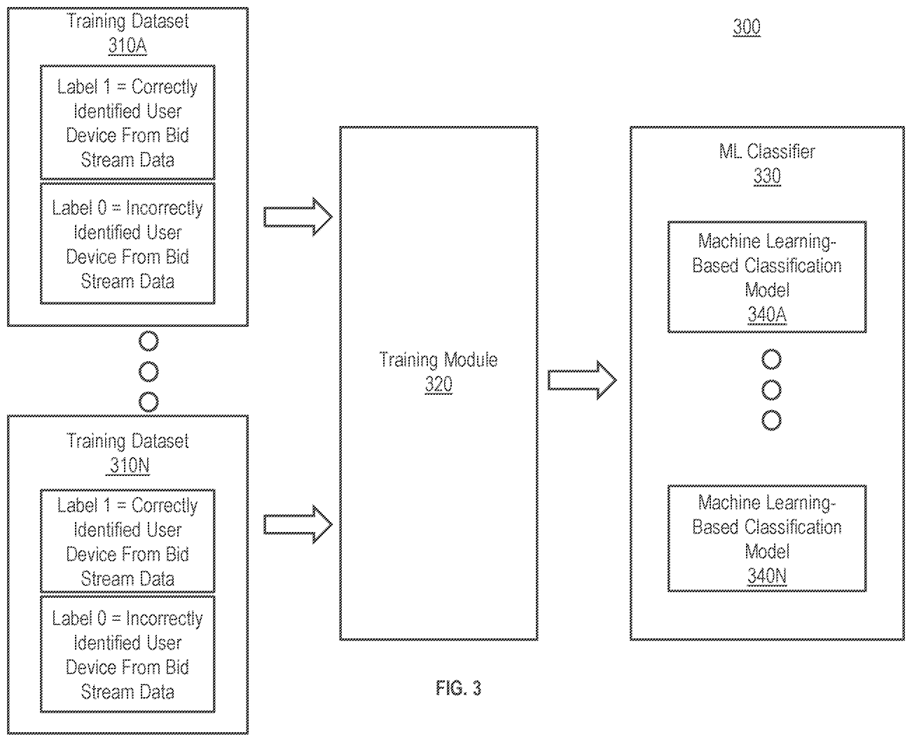

FIG. 3 is an example system 300 for training the identity management module 132 to determine a correspondence between user devices and user locations, for example, based on user information received/determine for a user device, according to some aspects of this disclosure. FIG. 3 is described with reference to FIG. 1.

According to some aspects of this disclosure, the system 300 may use machine learning techniques to train at least one machine learning-based classifier 330 (e.g., a software model, neural network classification layer, etc.). The machine learning-based classifier 330 may be trained by the identity management module 132 based on an analysis of one or more training datasets 310A-310N. The machine learning-based classifier 330 may be configured to classify features extracted from user device communications, bid stream devices, third-party data sources, content/service provider tracking and/or telemetry data, etc. For example, the machine learning-based classifier 330 may classify features extracted from deterministic data (e.g., data identifying a single-family house, condo, apartment, and/or the like where devices will be used to consume content, media including streaming content, linear television, web browsing, and/or the like on a permanent basis, etc.), bid stream data (e.g., collected device information, user information, advertisement content information, context footprint information, etc.), and/or the like. According to aspects of this disclosure, all device information, user information, advertisement content information, and/or the like collected, managed, and/or described herein is utilized in accordance with and as permitted by any internet/data privacy laws, user privacy/consent laws, and/or the like.

According to some aspects of this disclosure, the machine learning-based classifier 330 may classify features extracted from user device communications, bid stream devices, third-party data sources, content/service provider tracking and/or telemetry data, and/or the like to identify attributes for and/or associated with a user device. Attributes for and/or associated with a user device may include, but are not limited to an indication of a service provider for a user device, an indication of a content provider associated with a content item previously sent to a user device, an indication of an amount of occasions that a user device has been within the proximity of a location, an indication of a duration of time a user device has been within the proximity of the location, an amount of requests for content items sent by a user device, and/or the like.

According to some aspects of this disclosure, the one or more training datasets 310A-310N may comprise labeled baseline data such as labels that indicate numerical features (e.g., incoming bids, impressions, responded bids, activities, etc.), temporal features (e.g., when events occur, etc.), alias types, content publishers, service providers, and/or the like. The labeled baseline data may include any number of feature sets. Feature sets may include, but are not limited to, labeled data that identifies extracted features from advertising-related communications/activities, such as advertising-related communications/activities for a particular location (e.g., location 101, etc.), user device, and/or user device type/configuration.

According to some aspects of this disclosure, the labeled baseline data may be stored in one or more databases. Data for identity management may be randomly assigned to a training dataset or a testing dataset. According to some aspects of this disclosure, the assignment of data to a training dataset or a testing dataset may not be completely random. In this case, one or more criteria may be used during the assignment, such as ensuring that similar user devices, similar locations, similar attributes of user device information, similar bid stream-related information, dissimilar user devices, dissimilar locations, dissimilar attributes of user device information, dissimilar bid stream-related information, and/or the like may be used in each of the training and testing datasets. In general, any suitable method may be used to assign the data to the training or testing datasets.

According to some aspects of this disclosure, the identity management module 132 may train the machine learning-based classifier 330 by extracting a feature set from the labeled baseline data according to one or more feature selection techniques. According to some aspects of this disclosure, the identity management module 132 may further define the feature set obtained from the labeled baseline data by applying one or more feature selection techniques to the labeled baseline data in the one or more training datasets 310A-310N. The identity management module 132 may extract a feature set from the training datasets 310A-310N in a variety of ways. The identity management module 132 may perform feature extraction multiple times, each time using a different feature-extraction technique. In some instances, the feature sets generated using the different techniques may each be used to generate different machine learning-based classification models 340. According to some aspects of this disclosure, the feature set with the highest quality metrics may be selected for use in training. The identity management module 132 may use the feature set(s) to build one or more machine learning-based classification models 340A-340N that are configured to determine and/or predict associations between unidentified user devices and deterministic locations/devices, and/or the like.

According to some aspects of this disclosure, the training datasets 310A-310N and/or the labeled baseline data may be analyzed to determine any dependencies, associations, and/or correlations between user devices, user device types, locations, content items, content item-related metrics (e.g., advertisement impressions, streaming times/periods, runtimes, impressions, impression frequency, etc.), and/or the like in the training datasets 310A-310N and/or the labeled baseline data. The term “feature,” as used herein, may refer to any characteristic of an item of data that may be used to determine whether the item of data falls within one or more specific categories. For example, the features described herein may comprise indications of user devices, user device types, locations, content items, content item-related metrics (e.g., advertisement impressions, streaming times/periods, runtimes, impressions, impression frequency, etc.), and/or any other characteristics.

According to some aspects of this disclosure, a feature selection technique may comprise one or more feature selection rules. The one or more feature selection rules may comprise determining which features in the labeled baseline data appear over a threshold number of times in the labeled baseline data and identifying those features that satisfy the threshold as candidate features. For example, any features that appear greater than or equal to 2 times in the labeled baseline data may be considered candidate features. Any features appearing less than 2 times may be excluded from consideration as a feature. According to some aspects of this disclosure, a single feature selection rule may be applied to select features or multiple feature selection rules may be applied to select features. According to some aspects of this disclosure, the feature selection rules may be applied in a cascading fashion, with the feature selection rules being applied in a specific order and applied to the results of the previous rule. For example, the feature selection rule may be applied to the labeled baseline data to generate information (e.g., indications of user devices, user device types, locations, content items, content item-related metrics (e.g., advertisement impressions, streaming times/periods, runtimes, impressions, impression frequency, etc.) that may be used for enhancing a deterministic identity graph with probabilistic data. A final list of candidate features may be analyzed according to additional features.

According to some aspects of this disclosure, the identity management module 132 may generate information (e.g., indications of user devices, user device types, locations, content items, content item-related metrics (e.g., advertisement impressions, streaming times/periods, runtimes, impressions, impression frequency, etc.) that may be used for enhancing a deterministic identity graph with probabilistic data based on a wrapper method. A wrapper method may be configured to use a subset of features and train the machine learning model using the subset of features. Based on the inferences that are drawn from a previous model, features may be added and/or deleted from the subset. Wrapper methods include, for example, forward feature selection, backward feature elimination, recursive feature elimination, combinations thereof, and the like. According to some aspects of this disclosure, forward feature selection may be used to identify one or more candidate user devices, user device types, locations, content items, content item-related metrics (e.g., advertisement impressions, streaming times/periods, runtimes, impressions, impression frequency, etc.), and/or the like. Forward feature selection is an iterative method that begins with no feature in the machine learning model. In each iteration, the feature which best improves the model is added until the addition of a new variable does not improve the performance of the machine learning model. According to some aspects of this disclosure, backward elimination may be used to identify one or more candidate user devices, user device types, locations, content items, content item-related metrics (e.g., advertisement impressions, streaming times/periods, runtimes, impressions, impression frequency, etc.), and/or the like. Backward elimination is an iterative method that begins with all features in the machine learning model. In each iteration, the least significant feature is removed until no improvement is observed on the removal of features. According to some aspects of this disclosure, recursive feature elimination may be used to identify one or more candidate user devices, user device types, locations, content items, content item-related metrics (e.g., advertisement impressions, streaming times/periods, runtimes, impressions, impression frequency, etc.), and/or the like. Recursive feature elimination is a greedy optimization algorithm that aims to find the best performing feature subset. Recursive feature elimination repeatedly creates models and keeps aside the best or the worst performing feature at each iteration. Recursive feature elimination constructs the next model with the features remaining until all the features are exhausted. Recursive feature elimination then ranks the features based on the order of their elimination.

According to some aspects of this disclosure, one or more candidate user devices, user device types, locations, content items, content item-related metrics (e.g., advertisement impressions, streaming times/periods, runtimes, impressions, impression frequency, etc.), and/or the like may be determined according to an embedded method. Embedded methods combine the qualities of filter and wrapper methods. Embedded methods include, for example, Least Absolute Shrinkage and Selection Operator (LASSO) and ridge regression which implement penalization functions to reduce overfitting. For example, LASSO regression performs L1 regularization which adds a penalty equivalent to an absolute value of the magnitude of coefficients and ridge regression performs L2 regularization which adds a penalty equivalent to the square of the magnitude of coefficients. According to some aspects of this disclosure, embedded methods may include unidentified/alias user devices being mapped to an embedding space to enable similarity between unidentified/alias user devices and deterministic user devices and/or locations to be identified. For example, unidentified/alias user devices may be inferred to be associated with a predetermined location and/or device from an identity graph (e.g., an embedding can be built from a graph by content items accessed, requested, and/or consumed by unidentified/alias user devices (e.g., user device(s) 103, etc.), and content items accessed, requested, and/or consumed at a predetermined location (e.g., location 101, etc.) and/or by a predetermined device (e.g., media device(s) 106, etc.).

According to some aspects of this disclosure, after identity management module 132 generates a feature set(s), the identity management module 132 may generate a machine learning-based predictive model 240 based on the feature set(s). A machine learning-based predictive model may refer to a complex mathematical model for data classification that is generated using machine-learning techniques. For example, this machine learning-based classifier may include a map of support vectors that represent boundary features. By way of example, boundary features may be selected from, and/or represent the highest-ranked features in, a feature set.

According to some aspects of this disclosure, the identity management module 132 may use the feature sets extracted from the training datasets 310A-310N and/or the labeled baseline data to build a machine learning-based classification model 340A-340N to determine and/or predict user devices, user device types, locations, content items, content item-related metrics (e.g., advertisement impressions, streaming times/periods, runtimes, impressions, impression frequency, etc.), and/or the like. According to some aspects of this disclosure, the machine learning-based classification models 340A-340N may be combined into a single machine learning-based classification model 340. Similarly, the machine learning-based classifier 330 may represent a single classifier containing a single or a plurality of machine learning-based classification models 340 and/or multiple classifiers containing a single or a plurality of machine learning-based classification models 340. According to some aspects of this disclosure, the machine learning-based classifier 330 may also include each of the training datasets 310A-310N and/or each feature set extracted from the training datasets 310A-310N and/or extracted from the labeled baseline data. Although shown separately, identity management module 132 may include the machine learning-based classifier 330.

According to some aspects of this disclosure, the extracted features from deterministic data and bid stream data (e.g., collected device information, user information, advertisement content information, context footprint information, etc.) may be combined in a classification model trained using a machine learning approach such as a siamese neural network (SNN); discriminant analysis; decision tree; a nearest neighbor (NN) algorithm (e.g., k-NN models, replicator NN models, etc.); statistical algorithm (e.g., Bayesian networks, etc.); clustering algorithm (e.g., k-means, mean-shift, etc.); other neural networks (e.g., reservoir networks, artificial neural networks, etc.); support vector machines (SVMs); logistic regression algorithms; linear regression algorithms; Markov models or chains; principal component analysis (PCA) (e.g., for linear models); multi-layer perceptron (MLP) ANNs (e.g., for non-linear models); replicating reservoir networks (e.g., for non-linear models, typically for time series); random forest classification; a combination thereof and/or the like. The resulting machine learning-based classifier 330 may comprise a decision rule or a mapping that uses deterministic data and bid stream data (e.g., collected device information, user information, advertisement content information, context footprint information, etc.) to determine and/or predict user devices, user device types, locations, content items, content item-related metrics (e.g., advertisement impressions, streaming times/periods, runtimes, impressions, impression frequency, etc.), and/or the like.

According to some aspects of this disclosure, the deterministic data and bid stream data (e.g., collected device information, user information, advertisement content information, context footprint information, etc.) and the machine learning-based classifier 330 may be used to determine and/or predict user devices, user device types, locations, content items, content item-related metrics (e.g., advertisement impressions, streaming times/periods, runtimes, impressions, impression frequency, etc.), and/or the like for the test samples in the test dataset. For example, the result for each test sample may include a confidence level that corresponds to a likelihood or a probability that the corresponding test sample accurately determines and/or predicts user devices, user device types, locations, content items, content item-related metrics (e.g., advertisement impressions, streaming times/periods, runtimes, impressions, impression frequency, etc.), and/or the like. The confidence level may be a value between zero and one that represents a likelihood that the determined/predicted user devices, user device types, locations, content items, content item-related metrics (e.g., advertisement impressions, streaming times/periods, runtimes, impressions, impression frequency, etc.), and/or the like are consistent with computed values. Multiple confidence levels may be provided for each test sample and each candidate (approximated) user device, user device type, location, advertisement, content item-related metric, content item, advertising supporting content and/or metric (e.g., advertisement impression, streaming time/period, runtime, impression, impression frequency, etc.), and/or the like. A top-performing candidate user device, user device type, location, advertisement, content item-related metric, content item, advertising supporting content and/or metric (e.g., advertisement impression, streaming time/period, runtime, impression, impression frequency, etc.), and/or the like may be determined by comparing the result obtained for each test sample with a computed user device, user device type, location, advertisement, content item-related metric, content item, advertising supporting content and/or metric (e.g., advertisement impression, streaming time/period, runtime, impression, impression frequency, etc.), and/or the like for each test sample. In general, the top-performing candidate user device, user device type, location, advertisement, content item-related metric, content item, advertising supporting content and/or metric (e.g., advertisement impression, streaming time/period, runtime, impression, impression frequency, etc.), and/or the like will have results that closely match the computed user device, user device type, location, advertisement, content item-related metric, content item, advertising supporting content and/or metric (e.g., advertisement impression, streaming time/period, runtime, impression, impression frequency, etc.), and/or the like. The top-performing candidate user devices, user device types, locations, content items, content item-related metrics (e.g., advertisement impressions, streaming times/periods, runtimes, impressions, impression frequency, etc.), and/or the like may be used for enhancing a deterministic identity graph with probabilistic data operations.

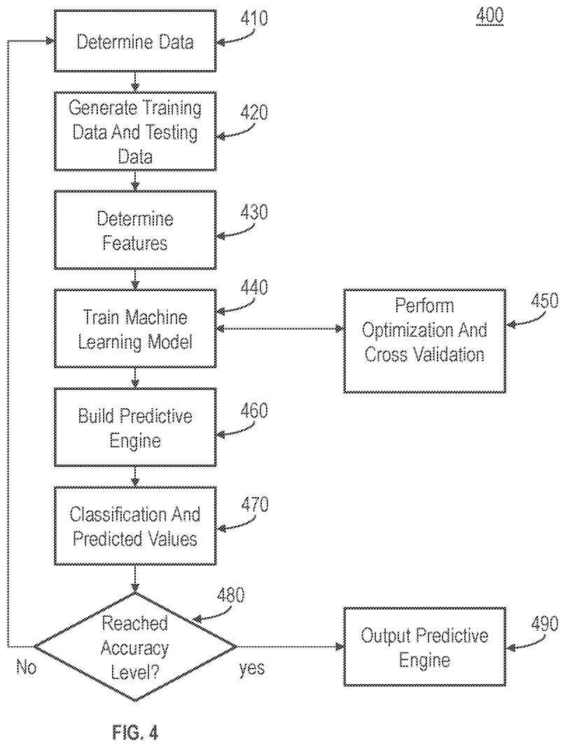

FIG. 4 is a flowchart illustrating an example training method 400. According to some aspects of this disclosure, method 400 configures machine learning classifier 330 for classification through a training process using the identity management module 132. The identity management module 132 can implement supervised, unsupervised, and/or semi-supervised (e.g., reinforcement-based) machine learning-based classification models 340. The method 400 shown in FIG. 4 is an example of a supervised learning method; variations of this example of training method are discussed below, however, other training methods can be analogously implemented to train unsupervised and/or semi-supervised machine learning (predictive) models. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art.

Method 400 shall be described with reference to FIGS. 1-3. However, method 400 is not limited to the aspects of those figures.

In 410, the identity management module 132 determines (e.g., accesses, receives, retrieves, etc.) user device information. According to some aspects of this disclosure, the user device information may be deterministic data mapping user devices to locations. According to some aspects of this disclosure, user device information may be indicative of a service provider for a user device, a content provider associated with a content item previously sent to a user device, an amount of occasions that a user device has been within proximity of a location, an indication of a duration of time a user device has been within proximity of a location, an amount of requests for content items sent by a user device, and/or the like. User device information may be used to generate one or more datasets, each dataset associated with a user device, a user device type, a location, a content item, a content item-related metric (e.g., advertisement impression, streaming time/period, runtime, impression, impression frequency, etc.), and/or the like.

In 420, identity management module 132 generates a training dataset and a testing dataset. According to some aspects of this disclosure, the training dataset and the testing dataset may be generated by indicating a user device, a user device type, a location, a content item, a content item-related metric (e.g., advertisement impression, streaming time/period, runtime, impression, impression frequency, etc.), and/or the like. According to some aspects of this disclosure, the training dataset and the testing dataset may be generated by randomly assigning a user device, a user device type, a location, a content item, a content item-related metric (e.g., advertisement impression, streaming time/period, runtime, impression, impression frequency, etc.), and/or the like to either the training dataset or the testing dataset. According to some aspects of this disclosure, the assignment of information indicative of a user device, a user device type, a location, a content item, a content item-related metric (e.g., advertisement impression, streaming time/period, runtime, impression, impression frequency, etc.), and/or the like as training or test samples may not be completely random. According to some aspects of this disclosure, only the labeled baseline data for a specific feature extracted from specific user device information may be used to generate the training dataset and the testing dataset. According to some aspects of this disclosure, a majority of the labeled baseline data extracted from user device information and/or related data may be used to generate the training dataset. For example, 75% of the labeled baseline data for determining a user device, user device type, location, advertisement, content item-related metric, content item, advertising supporting content and/or metric (e.g., advertisement impression, streaming time/period, runtime, impression, impression frequency, etc.), and/or the like extracted from the user device information and/or related data may be used to generate the training dataset and 25% may be used to generate the testing dataset. Any method or technique may be used to create the training and testing datasets.

In 430, identity management module 132 determines (e.g., extract, select, etc.) one or more features that can be used by, for example, a classifier (e.g., a software model, a classification layer of a neural network, etc.) to label features extracted from a variety of user device information and/or related data. One or more features may comprise indications of user device, user device type, location, advertisement, content item-related metric, content item, advertising supporting content and/or metric (e.g., advertisement impression, streaming time/period, runtime, impression, impression frequency, etc.), and/or the like. According to some aspects of this disclosure, the identity management module 132 may determine a set of training baseline features from the training dataset. Features of content and/or content item data may be determined by any method.

In 440, identity management module 132 trains one or more machine learning models, for example, using the one or more features. According to some aspects of this disclosure, the machine learning models may be trained using supervised learning. According to some aspects of this disclosure, other machine learning techniques may be employed, including unsupervised learning and semi-supervised. The machine learning models trained in 340 may be selected based on different criteria (e.g., how close a predicted user device, user device type, location, advertisement, advertising supporting content, content item, content item-related metric, etc. is to an actual user device, user device type, location, advertisement, advertising supporting content, content item, content item-related metric, etc.), etc.) and/or data available in the training dataset. For example, machine learning classifiers can suffer from different degrees of bias. According to some aspects of this disclosure, more than one machine learning model can be trained.

In 450, identity management module 132 optimizes, improves, and/or cross-validates trained machine learning models. For example, data for training datasets and/or testing datasets may be updated and/or revised to include more labeled data indicating different user devices, user device types, locations, content items, content item-related metrics (e.g., advertisement impressions, streaming times/periods, runtimes, impressions, impression frequency, etc.), and/or the like.

In 460, identity management module 132 selects one or more machine learning models to build a predictive model (e.g., a machine learning classifier, a predictive engine, etc.). The predictive model may be evaluated using the testing dataset.

In 470, identity management module 132 executes the predictive model to analyze the testing dataset and generate classification values and/or predicted values.

In 480, identity management module 132 evaluates classification values and/or predicted values output by the predictive model to determine whether such values have achieved the desired accuracy level. Performance of the predictive model may be evaluated in a number of ways based on a number of true positives, false positives, true negatives, and/or false negatives classifications of the plurality of data points indicated by the predictive model. For example, the false positives of the predictive model may refer to the number of times the predictive model incorrectly predicted and/or determined a user device, user device type, location, advertisement, content item-related metric, content item, advertising supporting content and/or metric (e.g., advertisement impression, streaming time/period, runtime, impression, impression frequency, etc.), and/or the like. Conversely, the false negatives of the predictive model may refer to the number of times the machine learning model predicted and/or determined a user device, user device type, location, advertisement, content item-related metric, content item, advertising supporting content and/or metric (e.g., advertisement impression, streaming time/period, runtime, impression, impression frequency, etc.), and/or the like incorrectly, when in fact, the predicted and/or determined user device, user device type, location, advertisement, content item-related metric, content item, advertising supporting content and/or metric (e.g., advertisement impression, streaming time/period, runtime, impression, impression frequency, etc.), and/or the like matches an actual user device, user device type, location, advertisement, content item-related metric, content item, advertising supporting content and/or metric (e.g., advertisement impression, streaming time/period, runtime, impression, impression frequency, etc.), and/or the like. True negatives and true positives may refer to the number of times the predictive model correctly predicted and/or determined a user device, user device type, location, advertisement, content item-related metric, content item, advertising supporting content and/or metric (e.g., advertisement impression, streaming time/period, runtime, impression, impression frequency, etc.), and/or the like. Related to these measurements are the concepts of recall and precision. Generally, recall refers to a ratio of true positives to a sum of true positives and false negatives, which quantifies the sensitivity of the predictive model. Similarly, precision refers to a ratio of true positives as a sum of true and false positives.

In 490, identity management module 132 outputs the predictive model (and/or an output of the predictive model). For example, identity management module 132 may output the predictive model when such a desired accuracy level is reached. An output of the predictive model may end the training phase.

According to some aspects of this disclosure, when the desired accuracy level is not reached, in 490, identity management module 132 may perform a subsequent iteration of the training method 400 starting at 410 with variations such as, for example, considering a larger collection of user device information and/or related data.

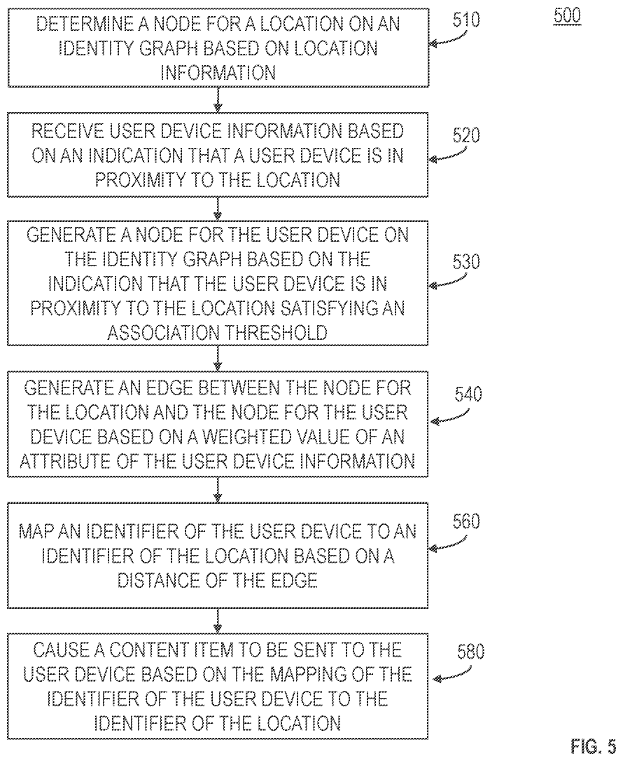

FIG. 5 shows a flowchart of an example method 500 for enhancing a deterministic identity graph with probabilistic data, according to some aspects of this disclosure. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art.

Method 500 shall be described with reference to FIGS. 1-4. However, method 500 is not limited to the aspects of those figures. A computer-based system (e.g., the multimedia environment 102, the system server(s) 126, etc.) may facilitate enhancing a deterministic identity graph with probabilistic data.

In 510, system server(s) 126 identifies a node for a location (e.g., location 101, a deterministic household, etc.) indicated by an identity graph that identifies user devices associated with locations. According to some aspects of this disclosure, system server(s) 126 may identify the node for the location indicated by the identity graph based on location information. For example, system server(s) 126 may receive, retrieve, access, and/or be configured with location information indicating a plurality of locations, and the location may be identified from the plurality of locations.

In 520, system server(s) 126 receives user device information. According to some aspects of this disclosure, system server(s) 126 may receive user device information based on an indication that a user device (e.g., a mobile device, a smart device, a computing device, user devices(s) 103, a bid stream-related device, etc.) is within proximity to the location. According to some aspects of this disclosure, system server(s) 126 may receive the user device information from the user device and/or another user device at the location. For example, According to some aspects of this disclosure, the user device information may be sent/received with a request for content, a content item, a resource, online information, and/or the like that is associated with service, service provider, content provider, business entity, etc. A request for content, a content item, a resource, online information, and/or the like that may be sent by the user device and/or routed/directed to a service, a service provider, a content provider, a business entity, and/or the like via another user device (e.g., communication device 114, media device(s) 106 at the location.

In 530, system server(s) 126 generates a node for the user device that is indicated by the identity graph. According to some aspects of this disclosure, system server(s) 126 may generate the node for the user device based on the indication of the user device satisfying an association threshold. The association threshold may indicate and/or be a measure of whether unidentified user devices are associated with locations.

In 540, system server(s) 126 generates an edge between the node for the location and the node for the user device. According to some aspects of this disclosure, system server(s) 126 may generate the edge between the node for the location and the node for the user device based on a weighted value for an attribute of the user information. According to some aspects of this disclosure, the weighted value for the attribute of the user information may be identified and/or determined by inputting the user device information into a predictive model (e.g., the identity management module 132, etc.). According to some aspects of this disclosure, the predictive model may be trained to forecast associations between user devices and locations based on attributes of the user devices and attributes of additional user devices at the locations. The weighted value for the attribute of the user information may be received from the predictive model. The weighted value for the attribute may indicate a forecasted degree of association between the node for the location and the node for the user device.

According to some aspects of this disclosure, the attribute of the user device information may include, but is not limited to an indication of a service provider for the user device, an indication of a content provider (e.g., a publisher, an advertiser, a marketer, a content creator, etc.) associated with a content item previously sent to the user device, an indication of an amount of occasions that the user device has been within the proximity of the location, an indication of a duration of time the user device has been within the proximity of the location, an amount of requests for content items sent by the user device, and/or the like. The attribute of the user device may include and/or be based on any other qualitative and/or temporal aspects associated with communications and/or activities with the user device and/or the location including, but not limited, to advertising-related communications/activities and/or the like.

In 560, system server(s) 126 maps an identifier for the user device to an identifier of the location. According to some aspects of this disclosure, system server(s) 126 may map the identifier for the user device to the identifier of the location based on a distance of the edge being less than a distance threshold that indicates degrees of association between nodes of the identity graph. According to some aspects of this disclosure, mapping the identifier for the user device to the identifier of the location may include associating a probabilistic identifier (e.g., an Internet Protocol (IP) address, a media access control (MAC) address, a service identifier, an international mobile equipment identity (IMEI), a session identifier, etc.) of the user device with a pre-determined and/or deterministic identifier of the location and/or additional user devices at or associated with the location.

In 580, system server(s) 126 causes a content item to be sent to the user device.

According to some aspects of this disclosure, system server(s) 126 may causes the content item to be sent to the user device based on the identifier for the user device being mapped to the identifier of the location. For example, system server(s) 126 may send an instruction and/or a request to a content provider and/or a content provider device (e.g., an advertisement server, the content server(s) 120, an application server, etc.) to send the content item to the user device. According to some aspects of this disclosure, the content item sent to the user device may be associated with a content item sent to another user device at the location by the content provider, the content provider device, and/or the like.

According to some aspects of this disclosure, method 500 may further include system server(s) 126 sending an indication of the mapping of the identifier for the user device to the identifier of the location to a content provider and/or a content provider device. System server(s) 126 may receive from the content provider and/or the content provider device a bid for information describing the mapping of the identifier for the user device to the identifier of the location. For example, the information describing the mapping of the identifier for the user device to the identifier of the location may be used to identify, request, and/or associate bid stream information to the user device, the location, a content provider, a content provider device, and/or the like.

### Example Computer System

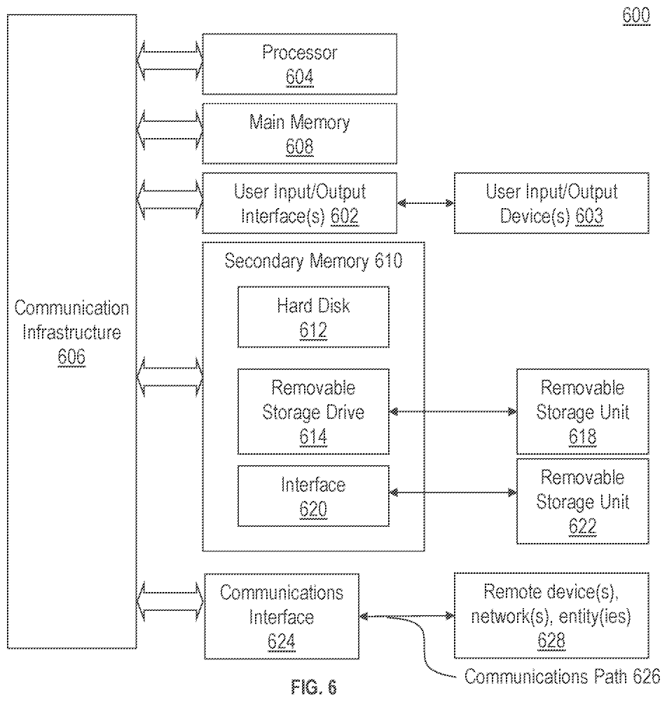

Various embodiments may be implemented, for example, using one or more well-known computer systems, such as computer system 600 shown in FIG. 6. For example, the media device 106 may be implemented using combinations or sub-combinations of computer system 600. Also or alternatively, one or more computer systems 600 may be used, for example, to implement any of the embodiments discussed herein, as well as combinations and sub-combinations thereof.

Computer system 600 may include one or more processors (also called central processing units, or CPUs), such as a processor 604. Processor 604 may be connected to a communication infrastructure or bus 606.

Computer system 600 may also include user input/output device(s) 603, such as monitors, keyboards, pointing devices, etc., which may communicate with communication infrastructure 606 through user input/output interface(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600 or processor(s) 604), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

### CONCLUSION

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method for enhancing a deterministic identity graph with probabilistic data, comprising:
determining, based on location information, a node for a location indicated by an identity graph that identifies user devices associated with locations;
receiving, based on an indication that a user device is within a proximity to the location, user device information;
generating, based on the indication of the user device satisfying an association threshold that indicates whether unidentified user devices are associated with locations, a node for the user device that is indicated by the identity graph;
generating, based on a weighted value for an attribute of the user information, an edge between the node for the location and the node for the user device;
mapping, based on a distance of the edge being less than a distance threshold that indicates degrees of association between nodes of the identity graph, an identifier for the user device to an identifier of the location; and
causing, based on the identifier for the user device being mapped to the identifier of the location, a content item to be sent to the user device.

2. The computer-implemented method of claim 1, wherein the content item sent to the user device is associated with a content item sent to another user device at the location.

3. The computer-implemented method of claim 1, further comprising:
inputting, to a predictive model trained to forecast associations between user devices and locations based on attributes of the user devices and attributes of additional user devices at the locations, the user device information; and
receiving the weighted value for the attribute of the user information, wherein the weighted value for the attribute indicates a forecasted degree of association between the node for the location and the node for the user device.

4. The computer-implemented method of claim 1, wherein the attribute of the user device information comprises at least one of: an indication of a service provider for the user device, an indication of a content provider associated with a content item previously sent to the user device, an indication of an amount of occasions that the user device has been within the proximity of the location, an indication of a duration of time the user device has been within the proximity of the location, or an amount of requests for content items sent by the user device.

5. The computer-implemented method of claim 1, wherein the receiving the user device information comprises receiving the user device information from at least one of the user device or another user device at the location.

6. The computer-implemented method of claim 1, further comprising:
sending, to a content provider device, an indication of the mapping of the identifier for the user device to the identifier of the location; and
receiving from the content provider device, a bid for information describing the mapping of the identifier for the user device to the identifier of the location.

7. The computer-implemented method of claim 1, further comprising receiving, based on an interaction with a user interface, the location information.

8. A system, comprising:
one or more memories;
at least one processor each coupled to at least one of the memories and configured to perform operations comprising:
determining, based on location information, a node for a location indicated by an identity graph that identifies user devices associated with locations;
receiving, based on an indication that a user device is within a proximity to the location, user device information;
generating, based on the indication of the user device satisfying an association threshold that indicates whether unidentified user devices are associated with locations, a node for the user device that is indicated by the identity graph;
generating, based on a weighted value for an attribute of the user information, an edge between the node for the location and the node for the user device;
mapping, based on a distance of the edge being less than a distance threshold that indicates degrees of association between nodes of the identity graph, an identifier for the user device to an identifier of the location; and
causing, based on the identifier for the user device being mapped to the identifier of the location, a content item to be sent to the user device.

9. The system method of claim 8, wherein the content item sent to the user device is associated with a content item sent to another user device at the location.

10. The system method of claim 8, the operations further comprising:
inputting, to a predictive model trained to forecast associations between user devices and locations based on attributes of the user devices and attributes of additional user devices at the locations, the user device information; and
receiving the weighted value for the attribute of the user information, wherein the weighted value for the attribute indicates a forecasted degree of association between the node for the location and the node for the user device.

11. The system method of claim 8, wherein the attribute of the user device information comprises at least one of: an indication of a service provider for the user device, an indication of a content provider associated with a content item previously sent to the user device, an indication of an amount of occasions that the user device has been within the proximity of the location, an indication of a duration of time the user device has been within the proximity of the location, or an amount of requests for content items sent by the user device.

12. The system method of claim 8, wherein the receiving the user device information comprises receiving the user device information from at least one of the user device or another user device at the location.

13. The system method of claim 8, the operations further comprising:
sending, to a content provider device, an indication of the mapping of the identifier for the user device to the identifier of the location; and
receiving from the content provider device, a bid for information describing the mapping of the identifier for the user device to the identifier of the location.

14. The system method of claim 8, the operations further comprising receiving, based on an interaction with a user interface, the location information.

15. A non-transitory computer-readable medium having instructions stored thereon that, when executed by at least one computing device, cause the at least one computing device to perform operations comprising:
determining, based on location information, a node for a location indicated by an identity graph that identifies user devices associated with locations;
receiving, based on an indication that a user device is within a proximity to the location, user device information;
generating, based on the indication of the user device satisfying an association threshold that indicates whether unidentified user devices are associated with locations, a node for the user device that is indicated by the identity graph;
generating, based on a weighted value for an attribute of the user information, an edge between the node for the location and the node for the user device;
mapping, based on a distance of the edge being less than a distance threshold that indicates degrees of association between nodes of the identity graph, an identifier for the user device to an identifier of the location; and
causing, based on the identifier for the user device being mapped to the identifier of the location, a content item to be sent to the user device.

16. The non-transitory computer-readable medium of claim 15, wherein the content item sent to the user device is associated with a content item sent to another user device at the location.

17. The non-transitory computer-readable medium of claim 15, the operations further comprising:
inputting, to a predictive model trained to forecast associations between user devices and locations based on attributes of the user devices and attributes of additional user devices at the locations, the user device information; and
receiving the weighted value for the attribute of the user information, wherein the weighted value for the attribute indicates a forecasted degree of association between the node for the location and the node for the user device.

18. The non-transitory computer-readable medium of claim 15, wherein the attribute of the user device information comprises at least one of: an indication of a service provider for the user device, an indication of a content provider associated with a content item previously sent to the user device, an indication of an amount of occasions that the user device has been within the proximity of the location, an indication of a duration of time the user device has been within the proximity of the location, or an amount of requests for content items sent by the user device.

19. The non-transitory computer-readable medium of claim 15, wherein the receiving the user device information comprises receiving the user device information from at least one of the user device or another user device at the location.

20. The non-transitory computer-readable medium of claim 15, the operations further comprising:
sending, to a content provider device, an indication of the mapping of the identifier for the user device to the identifier of the location; and
receiving from the content provider device, a bid for information describing the mapping of the identifier for the user device to the identifier of the location.
